(19) United States
(12) Patent Application Publication
(10) Pub. No.: US 2005/0222937 A1
(43) Pub. Date: Oct. 6, 2005

(54) Automated customer exchange

(76) Inventors: Edward J. Coad, Chatham, NJ (US); Kezia Samuel, Brooklyn, NY (US); Colin Reid, New York, NY (US); Robert Toffel, New York, NY (US)

Correspondence Address: DOCKET ADMINISTRATOR;LOWENSTEIN SANDLER PC, 65 LIVINGSTON AVENUE, ROSELAND, NJ, 07068, US

(21) Appl. No.: 10/814,954

(22) Filed: Mar. 31, 2004

(51) Int. Cl. G06F 17/60

(52) U.S. Cl. 705/37

(57) ABSTRACT

A system and method that automatically executes orders that a user enters into an entry screen at a global trade workstation. The order is routed to an order processing server, which opens a transaction record in a database. If the order is executable on an automated exchange, then the order is forwarded to that exchange. If the order is not executable on an automated exchange, then the order is sent to a front-end processor for non-automated exchanges. The front-end processor forwards the order electronically to the appropriate exchange. After execution of the transaction, the order processing server receives execution information from either the automated exchange or the front-end processor. The front-end processor matches this information to the order, stores the execution information and then forwards this information to the global trade workstation.

### FIELD OF THE INVENTION

This invention relates to the field of equities trading, and, more specifically, to a system and method that effects an automated customer exchange for use in trading options on both automated and non-automated exchanges.

### BACKGROUND OF THE INVENTION

Over the past few years, equity exchanges have become increasingly automated. The degree of automation, however, varies widely from exchange to exchange. For example, some exchanges have completely automated systems for order execution, while others rely on making telephone contact with a floor trader for order execution. In this inconsistent and ever-changing environment, brokers try to provide the most efficient service possible, so that a customer may obtain a specified price. Each broker must know and be able to use the appropriate tools (even if the appropriate tool is a telephone) in order to execute all of a customer's order(s).

Thus, there is a problem in the art that a user cannot trade on a plurality of exchanges from a single trading platform.

### SUMMARY OF THE INVENTION

This problem is solved and a technical advance is achieved in the art by a system and method that provides an automatic interface user for execution of all orders. A user enters an order into an order entry screen at a global trade workstation. The order is routed to a retail flow facilitation server, which opens a transaction record in a database. The security exchange for the order is then determined. If the order is executable on an automated exchange, then the order is forwarded to that exchange.

If the order is not executable on an automated exchange, then the order is sent to a broker/dealer system that provides order routing for exchanges that have “open out cry” and electronic systems. Orders are routed to the broker/dealer system, which manages the orders on the relevant trading floor as applicable and returns order fills over the system.

After the order has been executed, that is, a transaction has been completed to fill the order, the order processing server receives transaction information from either the automated exchange or the broker/dealer system. The order processing server matches this information to the order, stores the execution information in the database and then forwards this information to the global trade workstation.

Advantageously, contra orders may be generated and executed simultaneously. Furthermore, an instrument evidencing the transaction may be created. Further, one or more hedge positions may automatically be taken. Additionally, if an order is placed for more than a predetermined number of contracts on an automated exchange, then a facilitation order may be placed simultaneously. If the order is less than the predetermined number of contracts on the automated exchange, then an order and a contra order may automatically be placed.

### BRIEF DESCRIPTION OF THE DRAWING

A more complete understanding of this invention may be obtained from a consideration of this specification taken in conjunction with the drawings, in which:

FIG. 1 is a block diagram of an automated customer exchange in accordance with an exemplary embodiment of this invention;

FIG. 2 is a screen shot of an options entry screen of FIG. 1;

FIG. 3 is a screen shot of an order blotter in accordance with FIG. 1;

FIG. 4 is a block diagram of a FIX AFFIA engine of FIG. 1;

FIG. 5 is a thread diagram of instrument creation in accordance with one aspect of this invention; and

FIG. 6 is a thread diagram of trade booking for contra orders in accordance with another aspect of this invention.

### DETAILED DESCRIPTION

This specification describes the functionality of a system that automates options trading from end to end, including countering, hedging, etc., which are known in the art. While not all options exchanges can currently be accessed automatically, the exemplary embodiment of this invention extends automated trading as far as the technology of the individual exchange permits. One skilled in the art will appreciate how to modify the exemplary embodiment of this invention to incorporate additional exchanges as they increase in automation, after studying this specification. This invention is described in terms of automated options trading. One skilled in the art will appreciate how to apply the principles of this invention to other trading platforms after studying this specification.

The exemplary embodiment of this invention is conceptually an improvement upon extant options trading systems that communicate with diverse options exchanges and books trades into record systems (herein referred to as “retail flow facilitation”). Further, such systems perform risk management and hedging, either autonomously or as a plurality of interconnected systems.

For purposes of describing the exemplary embodiment of this invention, the retail flow facilitation system described herein comprises the InterAqt system, as uses by JP Morgan Chase (the assignee of this invention). One skilled in the art will appreciate how to apply the principles of this invention to other, similar systems.

A system in accordance with an exemplary embodiment of this invention enables marketers, private banking and futures and options groups to accept option orders from clients, guarantee filling of those orders at national best bid/offer (NBBO), route the orders to the appropriate exchanges, report the fills back to the trader and enables a retail flow facilitation desk to interact with the orders.

According to an exemplary embodiment of this invention, the enhancement to the current retail flow facilitation systems herein described provides marketers, private banking and futures and options groups the ability to:
1. enter option orders into a global trade workstation on their desktop,
2. monitor the execution of orders,
3. amend orders,
4. cancel orders, and
5. execute combinations of the above.

Further in accordance with an exemplary embodiment of this invention, the enhancement to the Retail flow facilitation server provides a trader with the ability to:
1. generate contra orders for each client order,
2. monitor contra orders for each client order,
3. amend contra orders for each client order,
4. cancel contra orders for each client order, and
5. execute combinations of the above.

Additionally, this enhancement to the current retail flow facilitation systems routes both client orders and contra orders for automated execution when appropriate, provides a user interface for the trader to manage the details of client orders and contra orders being worked through non-automated exchanges, or, advantageously, both. This enhancement uses retail flow facilitation infrastructure to provide pricing details, routing, order management and links to automatically hedge contra orders.

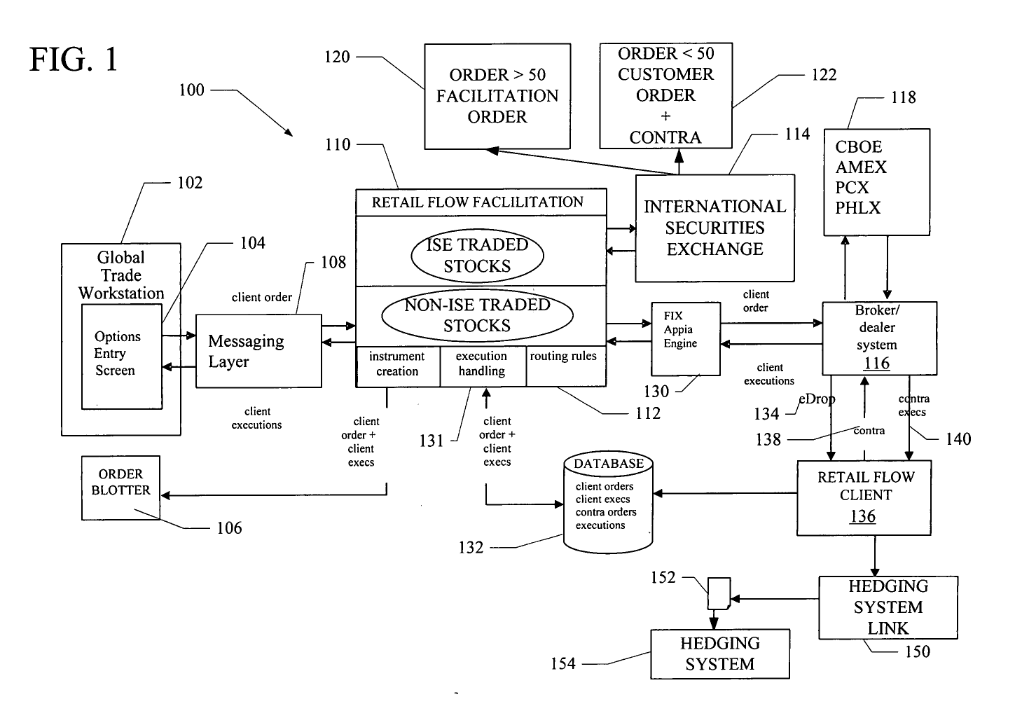

Turning now to FIG. 1, an overview block diagram of an exemplary embodiment of this invention is shown, generally at 100. A global trade workstation 102 provides an options entry screen 104 and an order tracking screen 106, called herein “order blotter.” In accordance with one aspect of this invention, options entry screen 104 is used to enter client orders and to view the execution details.

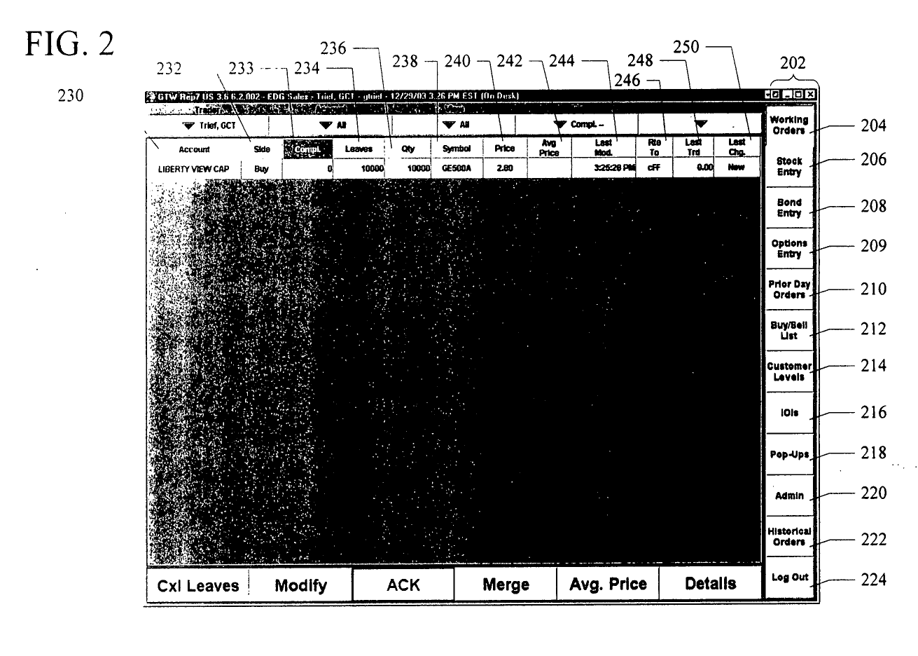

FIG. 2 is a screen shot of an exemplary options entry screen 104 in accordance with an embodiment of this invention. Options entry screen 104 includes a column of buttons 202 executable, for example, by the well-known “mouse click”. These buttons include (in this exemplary embodiment): “working orders” 204, “Stock Entry” 206, “Bond Entry” 208 “Prior Day Orders” 210, “Buy/Sell List” 212, “Options Entry” 209, “Customer Levels” 214, “IOI's” 216, “Pop-Ups” 218, “Admin.” 220, “Historical Orders” 222 and “Log Out” 224. One skilled in the art will recognize the relevance of each enumerated button 202. One skilled in the art will also recognize how to modify options entry screen 104 to use this invention in other applications.

In accordance with this illustration of options entry screen 104, “working orders” button 204 is active. The display for working orders includes “Account” 230, “Side” 232, “Complete” 233, “leaves” 234, “quantity” 236, “symbol” 238, “Price” 240, “Average price”, 242, “Last Modified” 244, “Rte To” 246, “Last Trade” 248 and “Last Chance” 250. As a transaction is in progress, the fields change to reflect execution of orders on one or more exchange (as will be explained further, below).

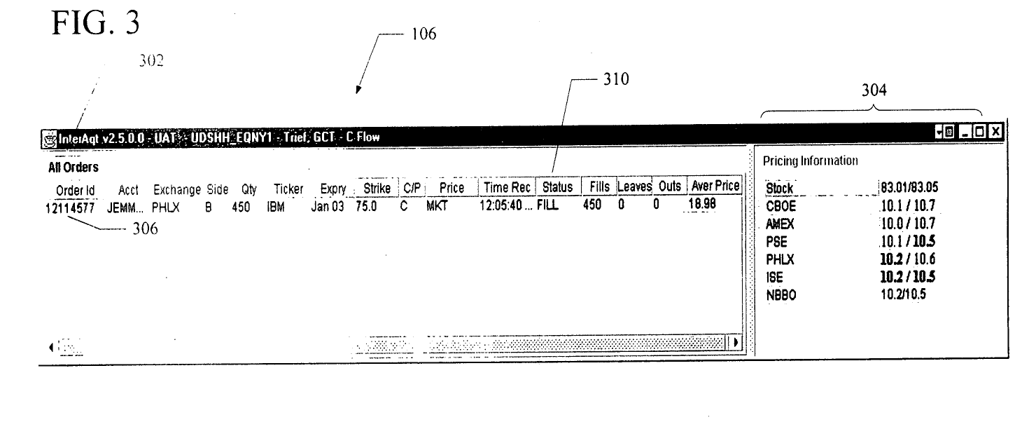

Turning briefly to FIG. 3, a sample layout of an order blotter 106 in accordance with this invention is illustrated. An order blotter 106 provides the following functionality:
1. displays client orders sent to exchanges at tab 302,
2. selectably displays the NBBO for an option 304,
3. displays confirmation of orders 306, and
4. displays all client executions.

Importantly, order blotter 106 displays a status 310 for each order. Status 310 may be:
1. Pending_new
2. New
3. Partial_fill
4. FILL
5. Rejected (REJ)=Primarily due to connectivity.
6. Pending_Cancel=Only for cancel. No modifications on this order will be accepted.
7. Cancelled (CAN)=Cancel confirmed. No modifications on this order will be accepted.
8. Pending_Replace=Awaiting cancel confirm from exchange in order to send out new order.
9. Cancel_Reject_TooLate=When an order has been executed before cancel gets there. (cancel/replace is handled as: Cancel order, await confirmation. Receive cancel confirmation, send new order).
10. Replace_Reject_TooLate=Execution quantity of order does not match replacement order.
11. Cancel_NewRejected (CAN_NEWREJ)->Only for Cancel/Replace: Once cancel is confirmed, a new order is rejected ( due to connectivity issues). No modifications on this order will be accepted.

Orders 302 are displayed according to a login id of the user, so that each user only views his/her order(s). Additionally, the NBBO 304 for each order is obtained from Reuters infrastructure, which is well known in the art and therefore not further discussed. Further in accordance with this exemplary embodiment, order blotter 106 also displays order details such as:
1. Account,
2. Exchange,
3. Side,
4. Quantity,
5. Ticker,
6. Expiry,
7. Strike,
8. C/P,
9. Price,
10. Time received,
11. cumulative leaves,
12. fills quantity,
13. out quantity, and
14. average price for executions.

While this invention is described in terms of the above-listed order details, one skilled in the art will appreciate that other details relevant to a trade may be added, substituted or both. In this exemplary embodiment, order blotter 106 is solely an order monitoring and management system.

Returning to FIG. 1, options entry screen 104 communicates bidirectionally over messaging layer 108. Messaging layer 108, in this exemplary embodiment, comprises a TCP/IP messaging component. Client orders from options entry screen 104 are delivered to retail flow facilitation server 110 and client executions from retail flow facilitation server 110 are delivered to options entry screen 104 via TCP/IP. In this exemplary embodiment, messaging layer 108 comprises a Data Distributor Messaging Layer. The basis of the Data Distributor Messaging Layer is provided by Omnesys (www.omnesys.com), which provides data/order entry and publishes execution information between options entry screen 104 and retail flow facilitation server 110.

Messaging layer 108 essentially comprises a message broker in accordance with one aspect of this invention. Messaging layer 108 is implemented using MML Base libraries and supports client processes built in a similar manner. In order to maintain high throughput capabilities and scalability, Messaging layer 108 processes are usually connected together to form a tree structure. As with all processes built using the MML base libraries, commands for controlling and configuring messaging layer 108 are sent via the MML utility admin to a Messaging Layer 108 admin socket. Communications between messaging layer and its clients transpire between the client's client socket and one of messaging layer 108 server sockets.

Retail flow facilitation server 110, in general, provides an automated interface for trading of options. Retail flow facilitation server 110, according to this exemplary embodiment of this invention, determines the type of trade, executes the trade, and reports the results. Only those aspects of retail flow facilitation server 110 relevant to this exemplary embodiment of this invention are described.

Retail flow facilitation server 110 includes a component comprising a plurality of routing rules 112 for proper routing of client orders. Client orders may be routed to International Securities Exchange 114, which is a fully automated securities exchange. International Securities Exchange 114 is well known in the art and is therefore not further described. Further, client orders may be routed to a non-automated exchange interface 116, also called a dealer/broker interface, which provides an automated front end for exchanges 118 that are not currently fully automated, including, but not limited to, CBOE, AMEX, PCX and PHLX.

For orders executable on International Securities Exchange 114, an attempt is made to guarantee the customer at global trade workstation 102 the NBBO. To this end, if the order size is greater than 50 contracts, a facilitation order is sent to International Securities Exchange 114, as illustrated in box 120. In this exemplary embodiment, the facilitation order response time comprises 10 seconds. The order itself must specify limit price. A contra order is then generated at International Securities Exchange 114, wherein the contra price equals the order price and the contra size is equal to the order size.

The retail flow facilitation server 110, on behalf of the service provider, can specify the service provider's interest in participation through a custom tag called “Broker Percent,” which is generally in the range of 0 to 40%. The service provider will cross the order at the given price if International Securities Exchange 114 cannot fill the order. Customer order cancels and cancel/replace orders are allowed within 10 seconds of sending the order (wherein the timer is reset after each transaction). According to this exemplary embodiment, facilitation orders are not price protected if NBBO is at an away market. If the price moves within 10 seconds of the time the order is placed, the order can either be cancelled or cancel/replaced (canceled and replaced with another order). If the order is not cancelled or cancel/replaced, then the customer order is filled at the price listed on the order.

While this exemplary embodiment is described in terms of 50 contracts being the critical number of contracts, one skilled in the art will realize that this is an exchange configurable parameter. Further, while the broker percentage is described as 40%, one skilled in the art will realize that this is also a configurable parameter.

If the order size is 50 contracts or less, as illustrated in box 122, then retail flow facilitation server 110 sends the customer order to International Securities Exchange 114, waits 30 seconds and then sends a contra order to cross the customer order. In the scenario of box 122, all customer orders can be price protected for an away market, if needed.

Continuing with the block diagram of FIG. 1, if the customer order cannot be processed by International Securities Exchange 114, then the customer order is sent to non-automated broker/dealer system 116. In accordance with this exemplary embodiment, there is no guarantee to the customers of NBBO for all orders sent to broker/dealer system 116.

Customer orders and executions are sent between retail flow facilitation server 110 and broker/dealer system 116 via FIX APPIA engine 130. Financial Information Exchange (FIX) is a message protocol used to transmit and receive information related to electronic financial transactions, such as orders, executions, cancels and other pre-trading, trading and post-trading related business messages. One FIX-enabled system can handle multiple connections and one FIX session can handle information pertaining to more than one recipient or firm. The FIX protocol is known in the art and defined at www.fixprotocol.org.

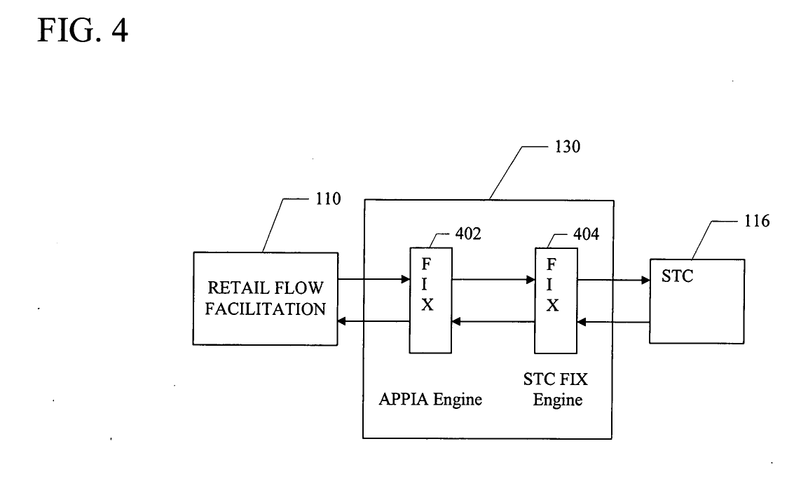

Turning briefly to FIG. 4, a FIX communications path 130 is illustrated in more detail. Retail flow facilitation server 110 is connected to, and in communications with an APPIA FIX engine 402, in accordance with an exemplary embodiment of this invention. APPIA FIX engine 402 communicates with an a FIX engine 404 provided by non-automated exchange interface 116. FIX engine 404 is connected to, and in communications with, non-automated exchange interface 116.

APPIA engine 402 provides the foundation for sending and receiving messages electronically across the front-, middle- and back-office. It enables users to communicate simultaneously in all FIX versions and across the entire FIX message suite. Counter-parties can communicate regardless of which FIX version they are running. Furthermore, future enhancements to the protocol are automatically incorporated as they are released. APPIA engine 602 is a scalable, layered communication framework implemented in Java and provides extended configuration and programming possibilities. All client orders and executions (contra and client) will be sent via FIX 4.2, in accordance with this exemplary embodiment. APPIA engine 402 is known in the art and is described in www.javtech.com/products/appia.htm, which is incorporated herein in its entirety.

Table II illustrates three new custom FIX tags required to support block and facilitation orders in accordance with an exemplary embodiment of this invention.

TABLE II

| Field | Description | Type | Code/Value |
|---|---|---|---|
| 9202 | SpecialOrdType | Char | B = Block order |
| | | | F = Facilitation |
| | | | order |
| 9203 | ExposureFlag | MultipleValueString | One or more space |
| | | | delimited values of: |
| | | | E = Expose All |
| | | | H = Hide All |
| | | | Q = Quantity |
| | | | T = TIF |
| | | | (Time-In-Force; |
| | | | Validity Time) |
| | | | I = Instruction |
| | | | (Buy/Sell) |
| | | | P = Premium |
| 9204 | BrokerPercent | Int | Valid values 0-100 |
| 526* | SecondaryCIOrdID | String | |

Returning to FIG. 1, routing rules 112 translate messages between messaging layer 108 and FIX formats. The following messages are supported (an exemplary message layout is set forth in the appendix listed by the message name):
1. New Order (Appendix 1)
2. Execution Report (Appendix 2)
3. Order Cancel Request (Appendix 3)
4. Order Cancel Reject (Appendix 4)
5. Order Status Request (Appendix 5)
6. Order Cancel/Replace (Appendix 6)
7. Execution Report New Order (Appendix 7) and
8. Execution Report Cancel (appendix 8).

The handling of the cancel/replace message is an exception to the routing rules. A cancel/replace is handled in the following manner:
1. Cancel existing order, await cancel confirmation. Once cancel has been confirmed, send new order.
2. Only price and quantity modifications (market [held] and limit only) are accepted.
3. If account and price or quantity is modified, the new account will be displayed on order blotter 106
4. If only account is modified, the changes are not displayed on order blotter 106, however, the transaction is captured in database 132.
5. If the exchange 118 is modified, retail flow facilitation server 110 ignores this modification and sends the order to wherever the NBBO for the order is.

Continuing in FIG. 1 with a client order to be executed via broker/dealer system 116, an order is created in a database 132 as “zero filled” and with a status of “open” by execution handling 131. Further in accordance with an exemplary embodiment of this invention, an “eDrop” 134 is generated at non-automated exchange interface 116 and sent to retail flow client 136. Retail flow client 136 is illustrated herein as being a separate block from retail flow facilitation server 110. One skilled in the art will realize that retail flow client 136 may be a 10 separate platform as illustrated, may be fully incorporated in retail flow facilitation server 110 or may execute across several platforms.

According to this exemplary embodiment of this invention, an “eDrop” 134 comprises an electronic copy of the customer order received from broker/dealer system 116. Before routing the order to retail flow client 136, non-automated exchange interface 116 sends the order to the exchange 118 with the best price. Retail flow client 136 receives the eDrop 134 with an indication of the exchange 118 that the order was delivered to. Table III illustrates information in an eDrop in accordance with an exemplary embodiment of this invention.

TABLE III

| Field | Data |
|---|---|
| Order Id | The order will be preceded by ‘S’ if it is a spread order and |
| | by ‘E’ if it is a single order. |
| Source | the source will be indicated as “service provider” specifying |
| | internal order flow. |
| Exchange | Exchange the order was routed to by BROKER/DEALER |
| | SYSTEM. |
| Side | Buy/Sell |
| Qty | Order size |
| Ticker | Product ID |
| Expry | Maturity of option |
| Strike | Strike of option |
| C/P | Call or Put |
| Price | A single price for all legs should be displayed. |
| Time | example: “12:13:47 PM” |
| Received | |
| BROKER/ | It is calculated only across the CBOE. This BBO does not |
| DEALER | reflect the prices across any other exchange. |
| SYSTEM | |
| BBO | |

The eDrop 134 is passed through a filter file at the retail flow client 136 to verify that the values for date therein is reasonable. If the eDrop 134 passes the filter, the eDrop 134 is processed through retail flow client 136 trading logic. All eDrops 134 received during a trading day are saved in the client image in database 132 until retail flow facilitation server 112 is shut down.

Contra orders 138 are generated by retail flow client 136 if the eDrop 134 passes the filter. Once a contra order 138 is generated, it is saved to database 132 (arrow 139). The decision on whether to trade a contra order is based on the service provider's perception of the fair value for each option and volatility data for each option. Non-automated exchange interface 116 sends the contra order to the various exchanges 118 and executions 140 on those contra orders are sent back to retail flow client 136 via non-automated exchange interface 116

Contras orders are displayed at retail flow 102 on an BROKER/DEALER SYSTEM Orders tab, with only one contra for a spread order on a single line. For both single leg order and spreads, the following data is displayed:

Theoretical Price

Bid/Ask

Contra Price

Theoretical Delta

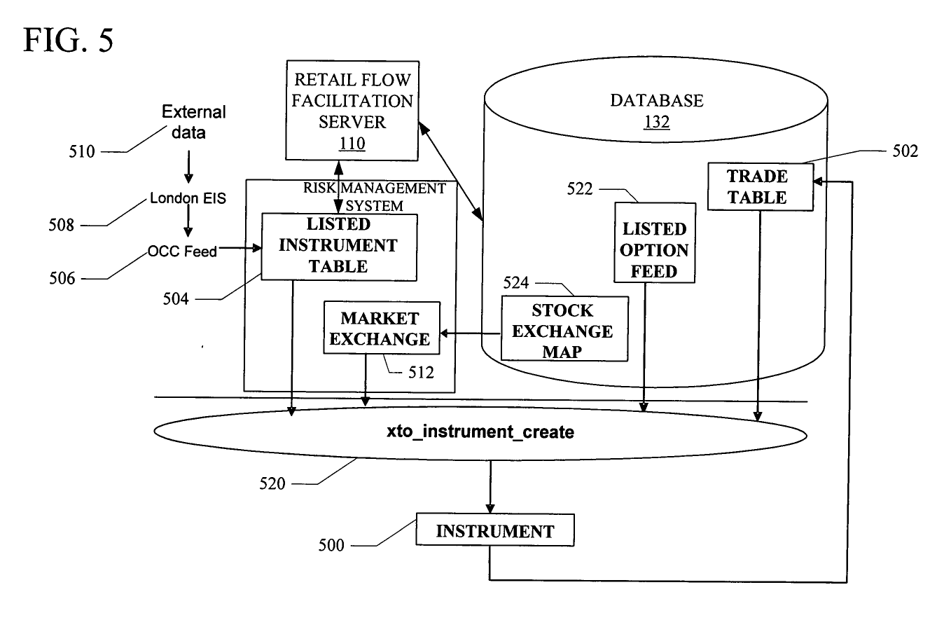

Turning now to FIG. 5, a thread diagram illustrating instrument creation is shown. Instrument creation is performed in an Instrument Management System (IMS). IMS is a portion of a larger system that manages risk. Such risk management system determines allocation of each transaction received from retail flow facilitation system 110 across portfolios and determines a relative risk position. Such systems are know in the art and therefore not further described.
1. Retail flow facilitation server 110 updates a trade table 502 in database 132. Retail flow facilitation server 110 checks a listed instrument table 504 to verify that the instrument exists (the listed instrument table 504 receives information from an OCC Feed 506. Every night, the OCC Feed 506 receives data from the EIS in London 408 (which obtains its information from an external company 510) about the option's underlying stock, expiry dates, strike prices, symbol and if it is a call or put. The listed instrument table 504 and a market exchange table 512, are located in CERD_CORPORATE, a GRD database in risk management. This database is shared by applications in risk management as well as the global trade workstation 102).
2. If the instrument is listed, the OrderID is sent back to trade table 502. If it is not listed, the retail flow facilitation server 110 calls the xto_instrument_create 520 process.
3. The instrument's RIC (id_opt_ric) is taken from a listed option feed table 522 in the database 132.
4. A stock exchange map table 524 in the database 132 is used to find the primary exchange according to the RIC. It sends the stock exchange map table 524 the id_exch_reuter, which returns the id_exchange_key to xto_instrument_create 520.
5. IMS uses all of these as inputs to update instrument table 504, which is stored in CERD_CORPORATE. All of the applications in risk management can now access the data on this instrument 500 from this database.
6. MS then sends the instrument 500 across a replication link to the global trade workstation 102.

After instrument creation, the status field in the trade table 502 is updated. If creation was successful, status=1, if unsuccessful, status=−1.

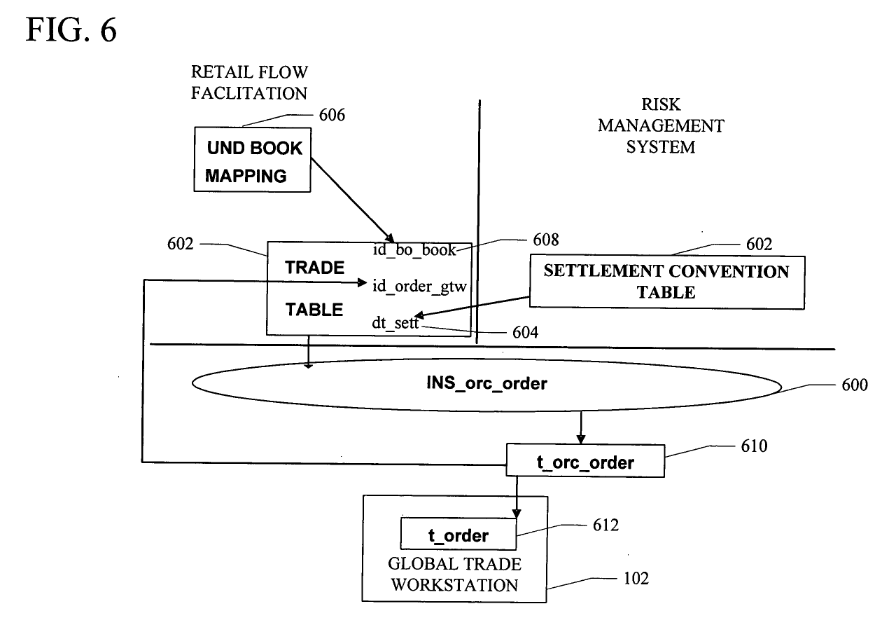

Turning now to FIG. 6, a thread diagram of trade booking for contra orders is shown. When the execution has an instrument ID, Retail flow facilitation server 110 sends it to global trade workstation 102 by invoking a process called INS_orc_order 600. INS_orc_order 600 performs the following steps:
1. The Settlement Convention table 602 in risk management updates the settlement date and time 604 of the trade in the Trade table 502.
2. The Trade table 502 also receives data from the Und Book Mapping table 606 for the id_bo_book field 608.
3. The information about the trade from the Trade table 502 is sent to INS_orc_order 600, which routes it into a t_orc_order table 610 and it is given a global trade workstation 102 order ID.
4. The t_orc_order table 610 then sends the Trade table 502 the global trade workstation 102 order ID, which—fills the id_ord_gtw field 612. The execution is simultaneously sent to the t_order table 614, which is the final stage in booking into the global trade workstation 102.

Hedging the order is now described in the context of FIG. 1. A link to the hedging system 159 receives order executions from retail flow facilitation server 110 and updates consolidated risk file 152 (as well as database 132, as described above). If there is no consolidated risk file 152, it is created. The user has to select a file and load it so the output risk data could be stored by the application. The link to the hedging system 150 then generates a consolidated risk file 152 across all bins for hedging system 154.

The hedging system link 150 receives executions from retail flow facilitation server 110 via FIX protocol and a client-side link to APPIA engine which is shared with hedging system 154. Executions are identified by OrderId and are converted from FIX format into string format using the parameters specified in the Trade Table 402.

It is to be understood that the above-described embodiment is merely illustrative of the present invention and that many variations of the above-described embodiment can be devised by one skilled in the art without departing from the scope of the invention. It is therefore intended that such variations be included within the scope of the following claims and their equivalents.

1. A method for providing a transaction interface to a plurality of exchanges, said plurality of exchanges comprising at least one automated exchange and at least one non-automated exchange, said method comprising:
receiving a client order comprising one or more contracts;
selecting one of the plurality of exchanges for execution of the client order based on the one or more contracts in the order;
delivering the order to the selected exchange for execution;
if the selected exchange is the at least one automated exchange, further processing said order to protect a position; and
if the selected exchange is the at least one non-automated exchange, monitoring said transaction in order to take a further position in the order's contracts, if necessary.

2. A method in accordance with claim 1 wherein selecting one of the plurality of exchanges is also based on a national best bid/offer price for the contracts.

3. A method in accordance with claim 1 wherein selecting one of the plurality of exchanges comprises selecting the at least one automated exchange if the order can be executed on the at least one automated exchange.

4. A method in accordance with claim 3 further including the step of:
placing a facilitation order on the at least one automated exchange if an order is placed for more than a predetermined number of contracts.

5. A method in accordance with claim 4 further including the step of:
placing a contra order against the order on the at least one automated exchange.

6. A method in accordance with claim 1 further including the step of creating an instrument evidencing the transaction.

7. A method in accordance with claim 1 further including the step of:
providing a monitoring system to monitor the status of the order.

8. A method in accordance with claim 7 further including the step of:
updating the monitoring system as each step occurs.

9. A method in accordance with claim 1 further including the step of:
automatically hedging the order.

10. A method in accordance with claim 1 further including the step of:
recording the execution of each step of the transaction.

11. A method in accordance with claim 1 further including the step of:
recording the execution of each step of the transaction in a database.
